(19) United States
(12) Patent Application Publication
(10) Pub. No.: US 2005/0001872 A1
(43) Pub. Date: Jan. 6, 2005

(54) Method for filtering objects to be separated from a media

(76) Inventor: Adam Jude Ahne, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/878,927

(22) Filed: Jun. 28, 2004

Related U.S. Application Data
(63) Continuation-in-part of application No. 10/612,771, filed on Jul. 2, 2003.

(51) Int. Cl. B41J 29/393

(52) U.S. Cl. 347/19

(57) ABSTRACT

A method for filtering objects to be separated from a media, including defining at least one cut path related to an object to be separated from the media; determining a characteristic of each cut path; comparing a result of the determination made in the determining step to a rejection criteria; suppressing cutting of any cut path that meets the rejection criteria; and cutting the media at each cut path that does not meet the rejection criteria.

### BACKGROUND OF THE INVENTION

1. Field of the Invention

This is a continuation-in-part of U.S. patent application Ser. No. 10/612,771, filed Jul. 2, 2003. The present invention relates to separating an object from a media, and, more particularly, to a method for filtering objects to be separated from a media.

2. Description of the Related Art

Various devices are available for performing perforation and/or cutting operations. However, many such devices are used in commercial applications, and are generally cost prohibitive to lower volume users. Also, such devices are often standalone devices, requiring the purchase of additional hardware. While some efforts have been directed to incorporating perforation or cutting devices into an imaging device, there still exists a need for a versatile imaging apparatus and associated method that enables low volume users to enjoy the benefits of perforation.

### SUMMARY OF THE INVENTION

The present invention, in one form thereof, is directed to a method for filtering objects to be separated from a media, including defining at least one cut path related to an object to be separated from the media; determining a characteristic of each cut path; comparing a result of the determination made in the determining step to a rejection criteria; suppressing cutting of any cut path that meets the rejection criteria; and cutting the media at each cut path that does not meet the rejection criteria.

The present invention, in another form thereof, is directed to a system including a mechanism for aiding in separating an object from a media. The system includes a controller that executes instructions for performing the steps of defining at least one cut path related to an object to be separated from the media; determining a characteristic of each cut path; comparing a result of the determination obtained in the determining step to a rejection criteria; suppressing cutting of any cut path that meets the rejection criteria; and cutting the media at each cut path that does not meet the rejection criteria.

The present invention, in still another form thereof, is directed to a method for forming perforations in a sheet of media with a perforation system, including identifying a plurality of perforation regions associated with a shape of an object to be perforated; adjusting a perforation density of the plurality of perforation regions in accordance with the shape of the object; and performing perforation of the sheet of media in accordance with the identifying and adjusting steps.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an imaging system employing an embodiment of the present invention.

FIG. 2A shows an end view of an embodiment of the perforator cartridge of the present invention.

FIG. 2B shows a side view of the perforator cartridge of FIG. 2A.

FIG. 2C shows a bottom view of one embodiment of the perforator cartridge of FIG. 2A.

FIG. 2D shows a bottom view of another embodiment of the perforator cartridge of FIG. 2A.

FIG. 3A is a diagrammatic representation of one embodiment of a perforation forming mechanism for the perforation cartridge of FIG. 2A.

FIG. 3B is a diagrammatic representation of another embodiment of a perforation forming mechanism for the perforation cartridge of FIG. 2A.

FIG. 3C is a diagrammatic representation of another embodiment of a perforation forming mechanism for the perforation cartridge of FIG. 2A.

FIG. 4 is a circuit diagram of a control circuit that can be used in the various embodiments of the perforation forming mechanisms of FIGS. 3A-3C.

FIG. 5A is a side diagrammatic view of the mid-frame region of the imaging apparatus of FIG. 1.

FIG. 5B is a side diagrammatic view showing another embodiment of the mid-frame of the imaging apparatus of FIG. 1.

FIG. 6 is a top diagrammatic view showing still another embodiment of the mid-frame of the imaging apparatus of FIG. 1.

FIG. 7 is a diagrammatic representation of an imaging system employing another embodiment of the present invention.

FIG. 8 is a flowchart of a method in accordance with the present invention.

FIG. 9A is an exemplary image used in explaining the invention.

FIG. 9B identifies various exemplary perforation boundaries associated with the image of FIG. 9A.

FIG. 10 is a flowchart of another method in accordance with the present invention.

FIG. 11 is block diagram of a perforation system employing an embodiment of the present invention.

FIG. 12 is a flowchart of still another method in accordance with the present invention.

FIG. 13 is a general flowchart of a method for performing perforation of an object using at least two different perforation densities.

FIG. 14 is a graphical depiction of a media, which includes an object to be perforated.

FIG. 15 is a graphical depiction of a computer screen, which includes objects that a user desires to print and separate from the media.

FIG. 16 is a graphical depiction illustrating how separation regions of the computer screen of FIG. 15 might be determined, in the absence of enhancements associated with the method represented in FIG. 17.

FIG. 17 is a general flow chart of a method for filtering objects to be separated from a media, in accordance with the present invention.

FIG. 18 is a graphical depiction illustrating respective cut paths of objects designated as a path to be cut, in accordance with the method represented in FIG. 17.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION OF THE INVENTION

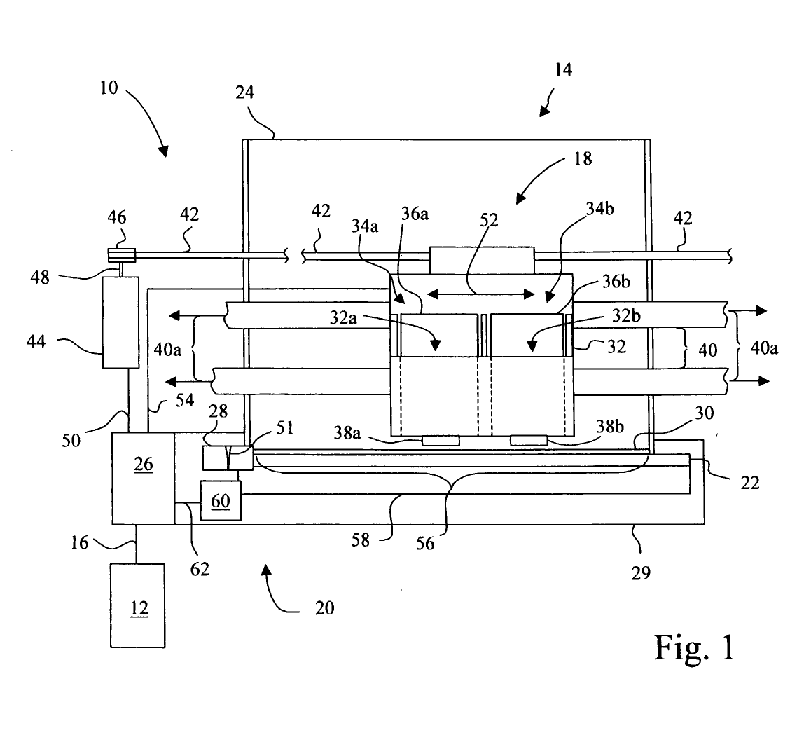

Referring now to the drawings and particularly to FIG. 1, there is shown an imaging system 10 employing an embodiment of the present invention. Imaging system 10 includes a computer 12 and an imaging apparatus in the form of an ink jet printer 14. Computer 12 is communicatively coupled to ink jet printer 14 by way of communications link 16. Communications link 16 may be, for example, a wired connection, an optical connection, such as an optical or r.f. connection, or a network connection, such as an Ethernet Local Area Network.

Computer 12 is typical of that known in the art, and may include a monitor to display graphics or text, an input device such as a keyboard and/or mouse, a microprocessor and associated memory, such as random access memory (RAM), read only memory (ROM) and a mass storage device, such as CD-ROM or DVD hardware. Resident in the memory of computer 12 is printer driver software. The printer driver software places print data and print commands in a format that can be recognized by ink jet printer 14.

Ink jet printer 14 includes a carrier system 18, a feed roller unit 20, a mid-frame 22, a media source 24, a controller 26 and a perforator maintenance station 28. Carrier system 18, feed roller unit 20, mid-frame 22, media source 24, controller 26 and perforator maintenance station 28 are coupled, e.g., mounted, to an imaging apparatus frame 29.

Media source 24 is configured and arranged to supply from a stack of print media a sheet of print media 30 to feed roller unit 20, which in turn further transports the sheet of print media 30 during a printing operation and/or a perforation operation.

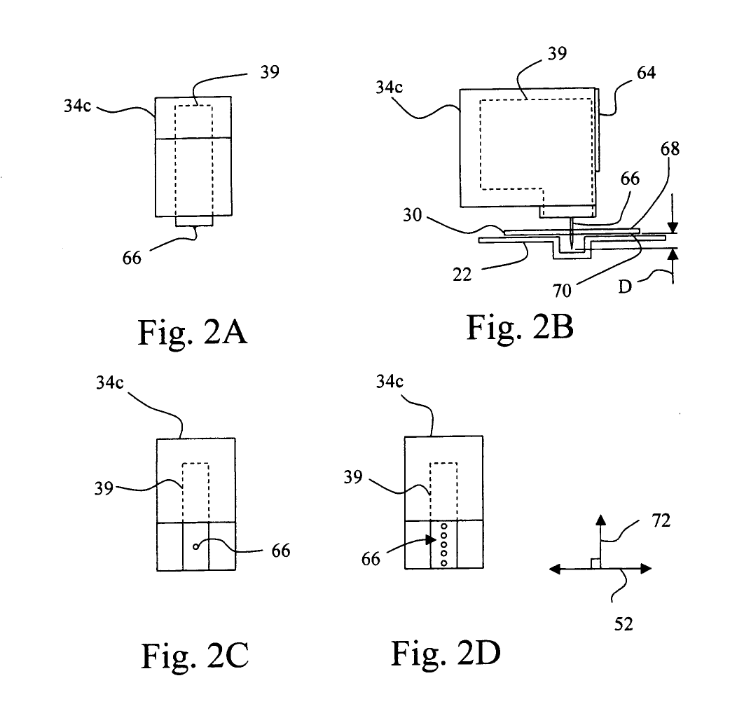

Carrier system 18 includes a carrier 32, i.e., carriage, that is configured with one or more bays, for example bay 32a and bay 32b. Each of bays 32a, 32b is mechanically and electrically configured to mount, carry and facilitate one or more types of cartridges, such as a monochrome printhead cartridge 34a and/or a color printhead cartridge 34b, and/or a perforator cartridge 34c (see FIGS. 2A-2D). Monochrome printhead cartridge 34a includes a monochrome ink reservoir 36a provided in fluid communication with a monochrome ink jet printhead 38a. Color printhead cartridge 34b includes a color ink reservoir 36b provided in fluid communication with a color ink jet printhead 38b. Alternatively, ink reservoirs 36a, 36b may be located off-carrier, and coupled to respective ink jet printheads 38a, 38b via respective fluid conduits. Perforator cartridge 34c is sized and configured to be mechanically and electrically compatible with the configuration of at least one of the printhead cartridges 34a, 34b so as to be interchangeable therewith in carriage 32, and includes a perforation forming mechanism 39.

Carriage 32 is guided by a pair of guide members 40. Either, or both, of guide members 40 may be, for example, a guide rod, or a guide tab formed integral with imaging apparatus frame 29. The axes 40a of guide members 40 define a bi-directional scanning path 52 of carriage 32. Carriage 32 is connected to a carrier transport belt 42 that is driven by a carrier motor 44 via a carrier pulley 46. In this manner, carrier motor 44 is drivably coupled to carriage 32 via carrier transport belt 42, although one skilled in the art will recognize that other drive coupling arrangements could be substituted for the example given, such as for example, a worm gear drive. Carrier motor 44 can be, for example, a direct current motor or a stepper motor. Carrier motor 44 has a rotating motor shaft 48 that is attached to carrier pulley 46. Carrier motor 44 is coupled, e.g., electrically connected, to controller 26 via a communications link 50.

Perforator maintenance station 28 includes an abrasive member 51, such as a ceramic material, arranged to receive and sharpen a perforation device, such as for example, a needle or a blade.

At a directive of controller 26, carriage 32 is transported in a controlled manner along bi-directional scanning path 52, via the rotation of carrier pulley 46 imparted by carrier motor 44. During printing, controller 26 controls the movement of carriage 32 so as to cause carriage 32 to move in a controlled reciprocating manner, back and forth along guide members 40. In order to conduct perforator maintenance operations, e.g., sharpening, controller 26 controls the movement of carriage 32 to position printhead carrier in relation to perforator maintenance station 28. The ink jet printheads 38a, 38b, or alternatively perforation forming mechanism 39, are electrically connected to controller 26 via a communications link 54. Controller 26 supplies electrical address and control signals to ink jet printer 14, and in particular, to the ink jetting actuators of ink jet printheads 38a, 38b, to effect the selective ejection of ink from ink jet printheads 38a, 38b, or to perforation forming mechanism 39 to effect the selective actuation of perforation forming mechanism 39.

During a printing operation, the reciprocation of carriage 32 transports ink jet printheads 38a, 38b across the sheet of print media 30 along bi-directional scanning path 52, i.e., a scanning direction, to define a print zone 56 of ink jet printer 14. Bi-directional scanning path 52, also referred to as scanning direction 52, is parallel with axes 40a of guide members 40, and is also commonly known as the horizontal direction. During each scan of carriage 32, the sheet of print media 30 is held stationary by feed roller unit 20. Feed roller unit 20 includes a feed roller 58 and a drive unit 60. The sheet of print media 30 is transported through print zone 56 by the rotation of feed roller 58 of feed roller unit 20. A rotation of feed roller 58 is effected by drive unit 60. Drive unit 60 is electrically connected to controller 26 via a communications link 62.

FIG. 2A shows an end view of an embodiment of perforator cartridge 34c, including perforation forming mechanism 39. FIG. 2B shows a side view of an embodiment of perforator cartridge 34c, including perforation forming mechanism 39, and shows an electrical interface 64, such as a tape automated bonded (TAB) circuit.

Perforation forming mechanism 39 includes at least one perforation device 66, which may include one or more needles or blades used in forming perforations in the sheet of print media 30. FIG. 2A shows perforation device 66 with a single needle (or blade) exposed, but in a retracted position. FIG. 2B shows perforation device 66 in relation to the sheet of print media 30 having a front side 68 and a back side 70, with back side 70 being supported by mid-frame 22. As shown in FIG. 2B, perforation device 66 has one needle (or blade) exposed, and extending through the sheet of print media 30 by a distance D, as measured from the back side 70 of the sheet of print media 30. Distance D may be, for example, 0.1 millimeters or greater. Depending on the shape of perforation device 66, such as if perforation device is a tapered needle, the distance that perforation device 66 extends through the sheet of print media 30 can effect the size of the perforation opening. Thus, controller 26 may control perforation forming mechanism 39 to drive perforation device 66 at selectable distances D in order to select a particular perforation opening size. Further, by controlling the distance D, perforation forming mechanism 39 can be used to create Braille indicia on the sheet of print media 30, which may be, for example, a transparency sheet or paper. For example, when perforation device 66 is driven through a transparency sheet, a volcano-shaped raised surface is formed on the back side of the transparency sheet.

Referring now to FIGS. 2C and 2D, perforation cartridge 34c can be configured having a single perforation device 66, as depicted in FIG. 2C, or alternatively, may be configured as depicted in FIG. 2D to have multiple perforation devices 66, e.g., multiple needles or blades, arranged, for example, in a column in a print media feed direction 72. Those skilled in the art will recognize that the multiple perforation devices 66 may be arranged in configurations other than a columnar arrangement, such as for example, slanted, staggered, curved, etc.

During a perforation operation, the reciprocation of carriage 32 transports perforator cartridge 34c, including perforation forming mechanism 39, across the sheet of print media 30 along bi-directional scanning path 52, i.e., a scanning direction, to define a perforation zone corresponding to print zone 56 of ink jet printer 14, and for convenience will also be referred to using the element number 56, i.e., perforation zone 56. The sheet of print media 30 is transported in print media feed direction 72 through perforation zone 56 by the rotation of feed roller 58 of feed roller unit 20.

Accordingly, in one embodiment, where perforation forming mechanism 39 has only a single perforation device 66, e.g., a single needle, then the maximum vertical perforation resolution (i.e., in a direction perpendicular to bi-directional scanning path 52, e.g., in print media feed direction 72) is limited to the minimum indexing distance of feed roller 58, while the horizontal perforation resolution (parallel to bi-directional scanning path 52) may be controlled to be as high as the horizontal printing resolution of printheads 38a, 38b, or lower. However, the extent of each perforation formed in the sheet of print media 30 may be increased by using a blade as perforation device 66. As used herein, the term perforation resolution refers to the maximum number of perforation holes in a given distance of the media, such as perforations per inch (ppi).

In another embodiment, where perforation forming mechanism 39 has multiple perforation devices 66, e.g., multiple needles or blades, arranged in a column in the print media feed direction 72, then the maximum vertical perforation resolution and the horizontal perforation resolution may be controlled to be a high as the printing resolution of printheads 38a, 38b, or lower.

Controller 26 is communicatively coupled to perforation forming mechanism 39 via communications link 54 and electrical interface 64 of perforation cartridge 34c. Controller 26 is configured, via hardware, firmware or software, to select either or both of the vertical perforation resolution and the horizontal perforation resolution. Such a selection may be based, for example, on media type (e.g., plain paper, photo paper, stickers, plastic, etc.), media thickness, or a resolution selected by a user. Alternatively, the perforation resolution may be established by computer 12, with perforation resolution commands or data being sent from computer 12 to controller 26.

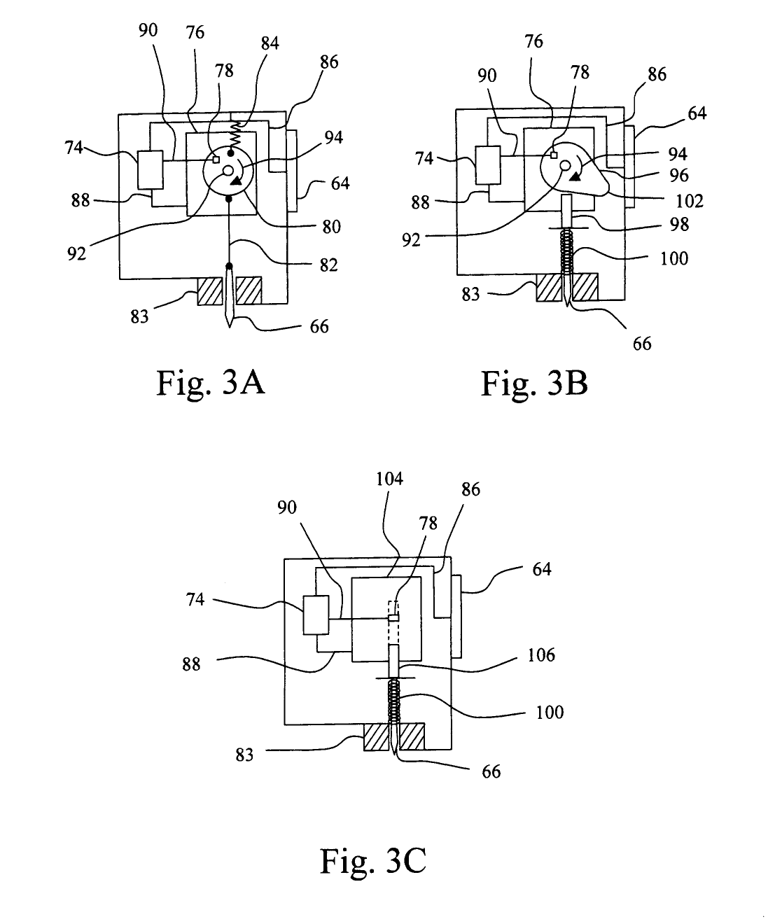

FIGS. 3A, 3B and 3C show three exemplary embodiments of perforation forming mechanism 39, each of which is discussed below.

FIG. 3A shows perforation forming mechanism 39 including, in addition to perforation device 66, a control circuit 74, a motor 76, a sensor 78, a flywheel 80, a linkage 82, a guide bushing 83, and a biasing spring 84. Electrical interface 64 of perforation cartridge 34c is connected to control circuit 74 via a communication link 86, such as for example, a multi-wire cable. Alternatively, electrical interface 64 can be formed on one side of a two layer printed circuit board, and control circuit 74 can be mounted on the opposite side of the printed circuit board. Also, control circuit 74 is connected to motor 76 via a communication link 88, and control circuit 74 is connected to sensor 78 via a communication link 90. Communications links 88 and 90 may be, for example, a multi-wire cable.

Motor 76 includes a shaft 92 connected to flywheel 80. Linkage 82 is pivotably coupled to each of flywheel 80 and perforation device 66. Guide bushing 83 establishes an orientation of perforation device 66, and provides a low friction inner guide surface that contacts perforation device 66. Also, the bottom surface of guide bushing 83 will release perforation device 66 from the sheet of print media 30 as the perforation device 66 is retracted into guide bushing 83, if the sheet of print media 30 become stuck to perforation device 66 during perforation.

A stroke of perforation device 66 may be established based on the location on flywheel 80 where linkage 82 is pivotably attached. As shown, a full rotation of flywheel 80, such as in the clockwise direction 94 as shown, will result in a full cycle of perforation device 66, e.g., from the fully retracted position to the fully extended position, and back to the fully retracted position. Alternatively, a full cycle of perforation device 66 may be performed, for example, by a clockwise half-rotation of flywheel 80 to extend perforation device 66 from the fully retracted position to the fully extended position, followed by a return counter-clockwise half-rotation to return perforation device 66 from the fully extended position to the fully retracted position. As a further alternative, by stopping the rotation of flywheel 80 before perforation device 66 has reached its fully extended position, the distance D that perforation device 66 extends through the sheet of print media 30 (see FIG. 2B) can be selectably controlled. Such control can be effected, for example, by configuring controller 26 to select distance D and control the stroke of perforation device 66 accordingly.

Sensor 78 senses a position of flywheel 80, such as a position indicia or feature representing a home (fully retracted) position. Alternatively, the position indicia, or feature, can be located near the home position, but not at the home position, such that sensor 78 is tripped just before flywheel 80 is at its home position. Also, it is contemplated that multiple position indicia or features may be established around flywheel 80, thereby providing a finer detection of the position of perforation device 66, and in turn, enabling better control over the position of perforation device 66. Such a position indicia or feature may be formed from a material having contrasting characteristics to that of the remainder of flywheel 80. For example, flywheel 80 may have a highly reflective finish except for the position indicia or feature, which has a light absorbing finish. Thus, sensor 78 supplies a signal to control circuit 74 so as to stop rotation of shaft 92 of motor 76, and in turn stop the rotation of flywheel 80, when sensor 78 senses the position indicia or feature on flywheel 80.

Biasing spring 84 is pivotably coupled to flywheel 80, and is located to aid the retention of flywheel 80 in the home position, and in turn, to aid the retention of perforation device 66 in its home (fully retracted) position.

FIG. 3B shows another embodiment of perforation forming mechanism 39, wherein flywheel 80, linkage 82, and biasing spring 84 of FIG. 3A is replaced with a cam 96, a cam follower 98 and a spring 100. Electrical interface 64 of perforation cartridge 34c is connected to control circuit 74 via communication link 86, such as for example, a multi-wire cable. Also, control circuit 74 is connected to motor 76 via communication link 88, and control circuit 74 is connected to sensor 78 via communication link 90.

Shaft 92 of motor 76 connected to cam 96. Cam follower 98 is coupled, e.g., connected to or integral with, perforation device 66. Guide bushing 83 establishes an orientation of perforation device 66, and provides a low friction inner guide surface that contacts perforation device 66. A stroke of perforation device 66 may be established based on the location of a cam lobe 102 on cam 96 in relation to cam follower 98. As shown, a full rotation of cam 96, such as in the clockwise direction 94 as shown, will result in a full cycle of perforation device 66, e.g., from the fully retracted position to the fully extended position, and back to the fully retracted position. Alternatively, a full cycle of perforation device 66 may be performed, for example, by a clockwise half-rotation of cam 96 to extend perforation device 66 from the fully retracted position to the fully extended position, followed by a return counter-clockwise half-rotation that returns perforation device 66 from the fully extended position to the fully retracted position. As a further alternative, by stopping the rotation of cam 96 before perforation device 66 has reached its fully extended position, the distance D that perforation device 66 extends through the sheet of print media 30 can be selectably controlled. Such control can be effected, for example, by configuring controller 26 to select distance D and control the stroke of perforation device 66 accordingly.

Sensor 78 senses a position of cam 96, such as a position indicia or feature representing a home (fully retracted) position. Such a position indicia or feature may be formed from a material having contrasting characteristics to that of the remainder of cam 96. For example, cam 96 may have a highly reflective finish except for the position indicia or feature, which has a light absorbing finish. Thus, sensor 78 supplies a signal to control circuit 74 so as to stop rotation of shaft 92 of motor 76, and in turn stop the rotation of cam 96, when sensor 78 senses the position indicia or feature on cam 96.

Spring 100 is positioned between cam follower 98 and guide bushing 83 to aid in biasing perforation device 66 in its home (fully retracted) position.

FIG. 3C shows another embodiment of perforation forming mechanism 39, wherein the motor 76 and cam follower 98 of FIG. 3B is replaced with a solenoid 104 and an armature 106. Electrical interface 64 of perforation cartridge 34c is connected to control circuit 74 via communication link 86, such as for example, a multi-wire cable. Also, control circuit 74 is connected to solenoid 104 via communication link 88, and control circuit 74 is connected to sensor 78 via communication link 90.

Armature 106 is displaced linearly upon the actuation of solenoid 104. Armature 106 is coupled, e.g., connected to or integral with, perforation device 66. Guide bushing 83 establishes an orientation of perforation device 66, and provides a low friction inner guide surface that contacts perforation device 66. A full cycle of perforation device 66 may be established based on the actuation of solenoid 104 to move perforation device 66 from the fully retracted position to the fully extended position, followed by the de-actuation of solenoid 104 to move perforation device 66 with the biasing aid of spring 100 back to the fully retracted position.

Sensor 78 senses a position of armature 106, such as a position indicia or feature representing a home (fully retracted) position. Such a position indicia or feature may be formed from a material having contrasting characteristics to that of the remainder of armature 106. For example, armature 106 may have a highly reflective finish except for the position indicia or feature, which has a light absorbing finish. Thus, sensor 78 supplies a signal to control circuit 74 to indicate when sensor 78 senses the position indicia or feature on armature 106.

In the various embodiments of FIGS. 3A-3C, sensor 78 will detect when perforation device 66 is not in the fully retracted (home) position, thereby indicating an error condition in the event that perforation device 66 gets stuck in the sheet of print media 30, e.g., remains out of its home position when controller 26 expects perforation device 66 to have returned to the home position.

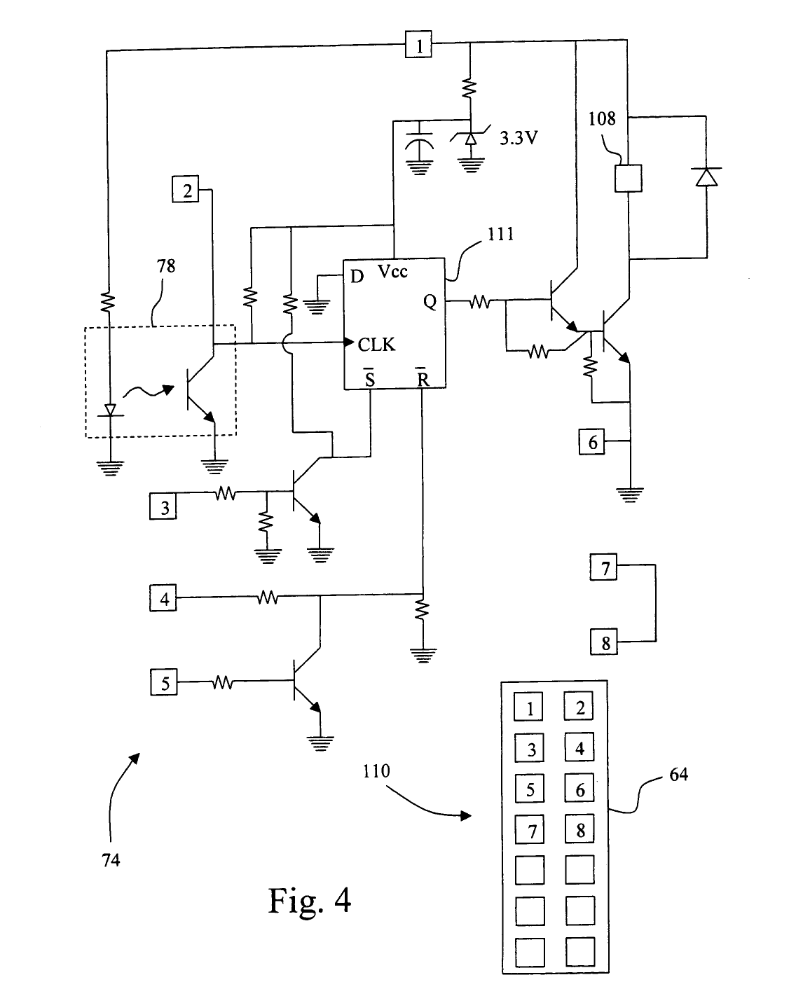

FIG. 4 is an exemplary circuit suitable for use as control circuit 74. Control circuit 74 includes sensor 78, various drive components, and a driven device 108. Driven device 108 represents motor 76 of the embodiments of FIGS. 3A and 3B, and represents solenoid 104 in the embodiment of FIG. 3C. As shown, electrical interface 64 includes a plurality of connection pads 110, with individual connection pads 110-1, 110-2, 110-3, 110-4, 110-5, 110-6, 110-7, and 110-8 being assigned connection points within control circuit 74. In control circuit 74, pads 110-7 and 110-8 are tied together, and in turn are used to indicate to controller 26 that cartridge 34c is in fact a perforation cartridge. Sensor 78 is used to supply a clock input to the D-flip-flop 111. Circuit power is supplied to control circuit 74 via pads 110-1 and 110-2. Controller 26 may set D-flip-flop 111 by supplying a signal to pad 110-3. Controller 26 may reset D-flip-flop 111 by supplying appropriate signals to pads 110-4 and 110-5. Circuit ground may be established, or may be monitored, via pad 110-6. Other aspects of the operation of control circuit 74, as shown in FIG. 4, are readily understood by one skilled in the art, and will not be further discussed herein.

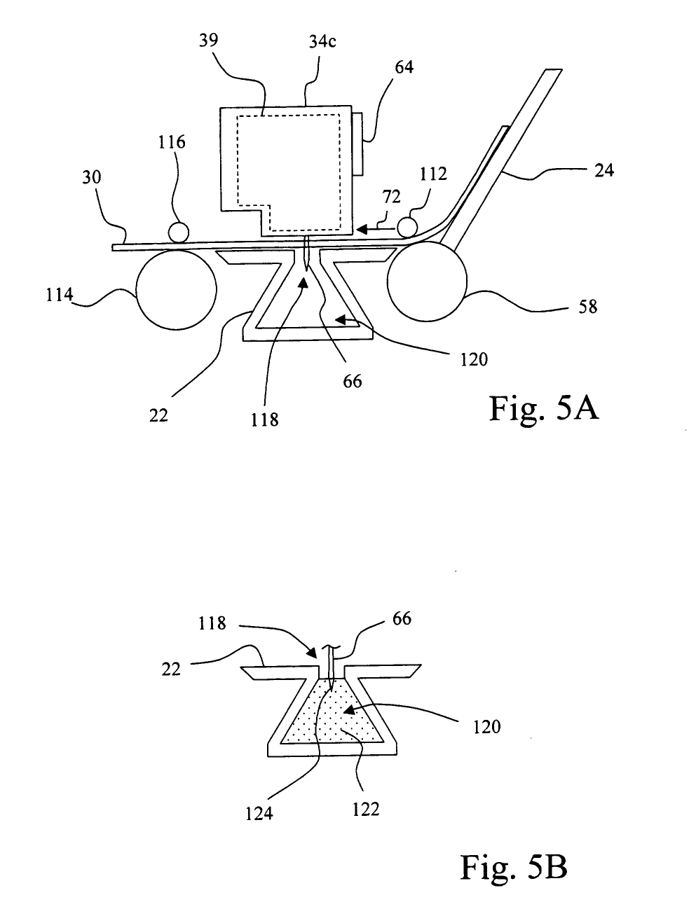

FIG. 5A shows a side diagrammatic view of a portion of printer 14, illustrating a perforation of the sheet of print media 30. As shown, the sheet of print media 30 is transported by feed roller 58 with the aid of its associated pinch roller 112, and by an exit roller 114 with the aid of an associated pinch roller 116. Thus, feed roller 58 is positioned upstream of perforation device 66, in relation to print media feed direction 72. In addition, exit roller 114 is positioned downstream of perforation device 66. As such, in one embodiment the sheet of print media 30 is suspended between feed roller 58 and exit roller 114 during perforation, as shown. Mid-frame 22 provides support for the sheet of print media 30 during perforation. Mid-frame 22 includes a trough 118 that extends along a width of mid-frame 22, e.g., an elongated opening that extends along perforation zone 56, for receiving perforation device 66 as perforation device 66 passes completely through the sheet of print media 30. Mid-frame 22, including trough 118, defines an interior region 120 that may be used for the accumulation of waste paper punch-outs generated during perforation. Trough 118 is configured with a depth such that perforation device 66 does not contact mid-frame 22, i.e., does not contact the bottom of trough 118, when perforation device 66 is at a fully extended position.

Alternatively, as shown in FIG. 5B, interior region 120 may be substantially filled with a foam 122. Foam 122 may be positioned to receive at least a tip portion 124 of perforation device 66, thereby performing a cleaning of perforation device 66 after each perforation. Foam 122 may be, for example, a polyurethane foam or sponge. As a further alternative, interior region 120 may be completely filled with foam to provide support to back side 70 of the sheet of print media 30 at trough 118.

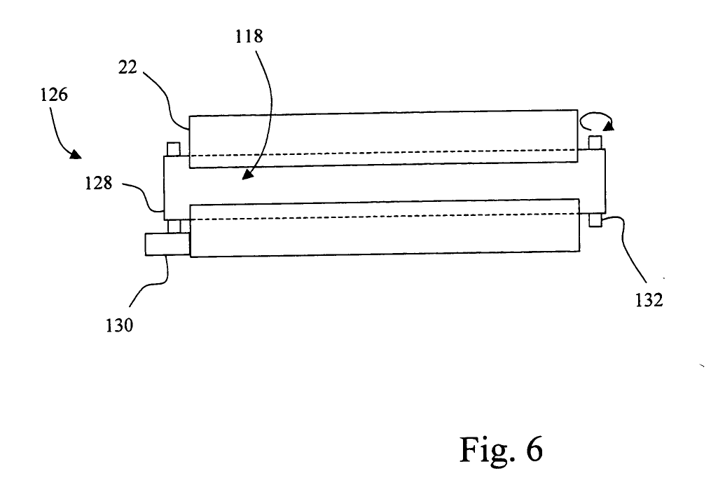

Referring now to FIG. 6, in relation to FIG. 5A, a conveyor unit 126 may be located in trough 118 in interior region 120 of mid-frame 22 to carry away the accumulation of waste paper punch-outs. Conveyer unit 126 includes a conveyor belt 128, a conveyor drive unit 130 and an idler unit 132. Conveyor belt 128 is suspended between conveyor drive unit 130 and an idler unit 132. Conveyor drive unit 130 provides a driving force to advance conveyor belt 128. Conveyor drive unit 130 may be, for example, a ratchet mechanism that increments conveyor belt 128 when conveyor drive unit 130 is engaged by carriage 32. Alternatively, conveyor drive unit 130 may be motor driven.

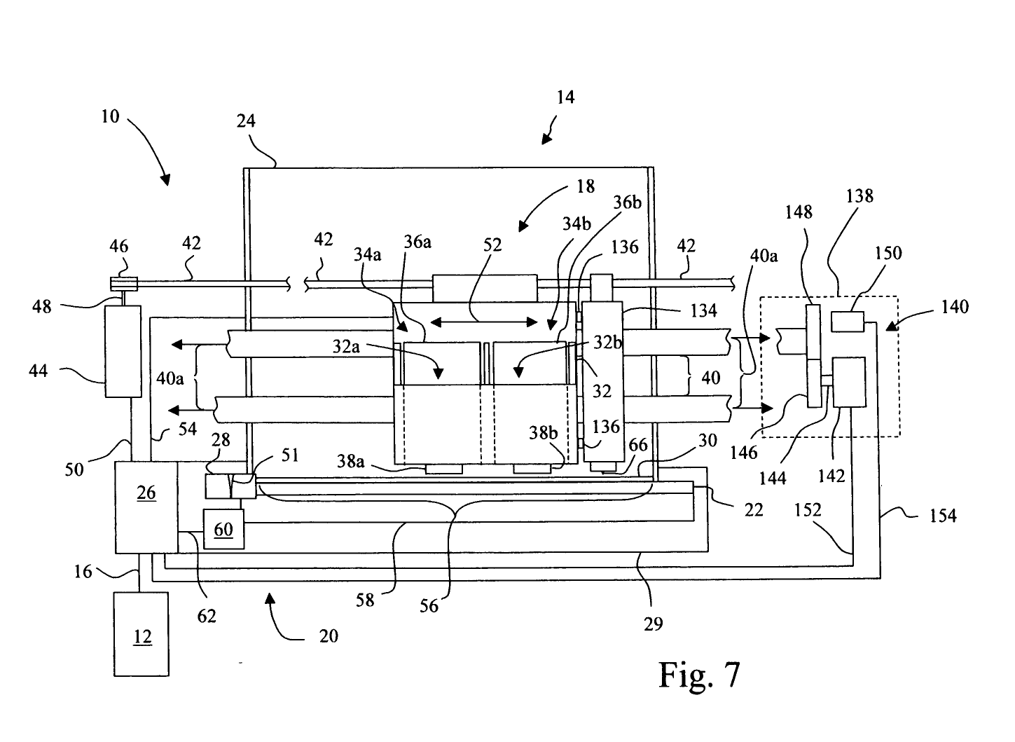

FIG. 7 shows still another embodiment of the invention, which includes a dedicated perforator carriage 134. In this embodiment, carriage 32 may be a dedicated printhead carriage. The various configurations of the invention as shown in FIGS. 5A, 5B and 6, as well as the perforation operating characteristics described above, can also be readily incorporated into the embodiment of FIG. 7. Perforator carriage 134 is connected to carrier transport belt 42, and is coupled to carriage 32 by isolation members 136. Isolation members 136 may be made, for example, of rubber or other material having elastic, vibration absorbing, characteristics. Carrier transport belt 42 may also act as an isolation member. Perforator carriage 134 may be adapted to carry a perforation forming mechanism, such as for example one of the perforations forming mechanisms described above with respect to FIGS. 3A-3C, or another perforation mechanism known in the art. As shown, perforator carriage travels with carriage 32 carrying printheads 38a, 38b in a unitary manner. However, isolation members 136 serve as isolation dampers so that operation of the perforator mechanism in perforator carriage 134 will not transmit mechanical vibrations directly to carriage 32, and in turn to printheads 38a, 38b.

Alternatively, as shown in the breakout section 138, the perforation forming mechanism in perforator carriage 134 may be driven by a perforation drive system 140. Perforation drive system 140 includes a motor 142 having a shaft 144 to which a gear 146 is attached. A second gear 148 is attached to one of the guide members 40. This particular guide member may be a guide rod having a D-shaped cross section, which when rotated emulates the operation of cam 96 of FIG. 3B to drive perforation device 66. Gears 146, 148 are located to be in meshed relation. Also shown is a sensor 150 that is used to detect the home position of D-shaped shaft 40. Motor 142 is electrically connected to controller 26 via a communication link 152. Sensor 150 is electrically connected to controller 26 via communication link 154.

In this embodiment, controller 26 provides perforation commands to motor 142, which responds by rotating D-shaped guide member 40, which drives the perforation forming mechanism in perforator carriage 134, which in turn causes perforation device 66 to extend from its home position to its perforation position. Further rotation of D-shaped guide member 40 results in perforation device 66 returning to its retracted (home) position, wherein sensor 150 provides a signal to controller 26 to turn off motor 142 to stop rotation of D-shaped guide member 40.

The discussion that follows is directed to describing various methods of the invention. Referring to the embodiment of FIG. 1, when perforator cartridge 34c is installed in carriage 32, imaging system 10 is converted into a dual use system, serving both as an imaging system and a perforation system and with imaging apparatus 14 serving as a perforation apparatus. Likewise, referring to the embodiment of FIG. 7, when imaging system 10 is modified to include perforator carriage 134, imaging system 10 is converted into a dual use system, serving both as an imaging system and a perforation system. Accordingly, in the discussions of the various methods of the invention that follow, sometimes for convenience reference will be made to a perforator system 10 to emphasize the perforation functionality of the system. Also, for convenience and ease of understanding, sometimes the methods of the invention will be described with reference to the embodiments of FIGS. 1 and 7. However, it is to be understood that the methods of the invention need not be limited to the embodiments of FIGS. 1 and 7.

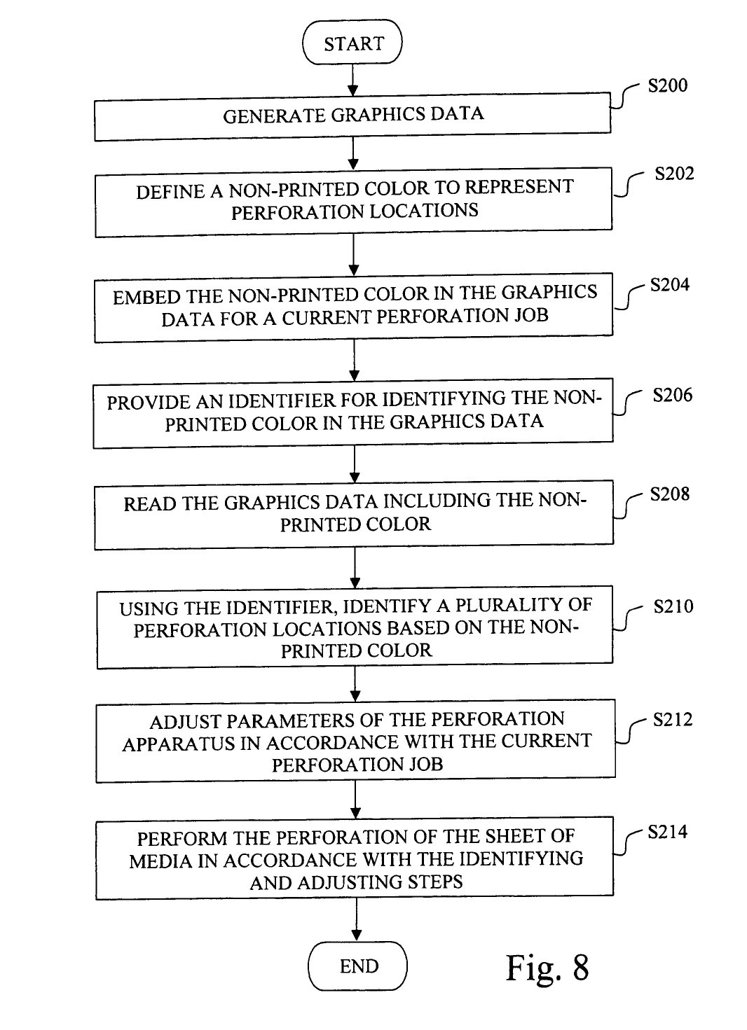

FIG. 8 is directed to a method of forming perforations in sheet of media with a perforation system, such as perforation system 10 that was described above with respect to FIGS. 1-7.

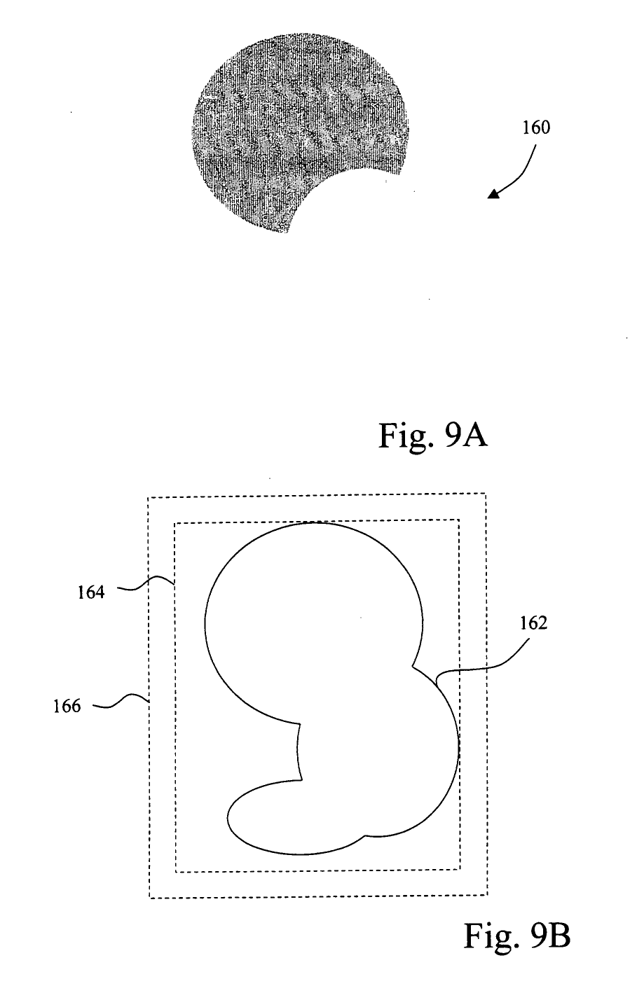

At step S200, graphics data is generated, such as by computer 12 executing a graphics application. Such graphics data may represent, for example, image 160 shown in FIG. 9A.

At step S202, a non-printed color is defined to represent perforation locations.

In one exemplary implementation, the non-printed color may be identifiable by its presence with a predefined sequence of colors. For example, the occurrence of a predefined sequence of two or more colors indicate that the color proceeding, or alternatively following, the predefined sequence is a non-printed color, e.g., the perforation color, which in turn is used to identify perforation locations in the graphics data. For example, the printer driver operating on computer 12, or alternatively imaging apparatus 14, can be programmed to identify the color sequence in the print data and in turn identify the perforation color used to signify a perforation location. Colors may be repeated in the sequence.

As an example, it is predefined that a three pixel color group, beginning with a two color sequence will be followed by the non-printed color, i.e., the perforation color. The three color group may be, for example, a sequence of a yellow pixel and a light gray pixel, followed by a dark gray pixel as the perforation color. When the printer driver operating on computer 12, or alternatively a routine operating in imaging apparatus 14, detects the yellow-light gray sequence of pixels, then the following pixel, e.g., a dark gray pixel, is interpreted and saved, for example in memory associated with computer 12 or controller 26, as a non-printed colorl to be used as a perforation location identifier. Thereafter, each time the printer driver operating on computer 12, or alternatively imaging apparatus 14, detects a dark gray pixel, the dark gray pixel is identified as a non-printed color and its location by definition is a perforation location which will receive a perforation.

In the present embodiment, the term non-printed color is used to indicate the absence of color at the perforation location after perforation, and thus, not only covers the condition where the perforation location does not receive ink during a printing operation since the perforation will eliminate the material in the sheet of print media 30 at the perforation location, but is intended to also cover the condition wherein the perforation color is first printed, and then removed by the perforation.

In another exemplary implementation, computer 12 may analyze the color data associated with the graphics data, and select a color as the non-printed color that is absent with respect to the graphics data. The non-printed color would still be identified based on the color sequence method described above.

At step S204, the non-printed color is embedded in the graphics data for a current perforation job. Based on boundary information, computer 12, executing a program such as in the printer driver, automatically inserts the predefined color sequence proceeded (or alternatively followed) by the non-printed color, i.e., perforation color, into the graphics data, preferably near the beginning of the graphics data, and then embeds the non-printed color at locations corresponding to the perforation boundary specified by the user.

In one implementation, a boundary detection algorithm may be used to automatically identify the perforation boundary of an image. The boundary detection algorithm may be incorporated, for example, into the printer driver, or may be incorporated into firmware in controller 26. The pseudo code for an exemplary boundary detection algorithm is attached in Appendix A. The pseudo code is in the form of a C++code snippet that demonstrates how a recursive flood fill algorithm can be used to find the edges of an image. FIG. 9A shows image 160 prior to processing through the boundary algorithm of Appendix A. FIG. 9B shows a boundary 162 of image 160 after processing through the boundary algorithm of Appendix A. As shown, the edges of boundary 162 do not need to be linear, although the edges may be linear. In the example of FIGS. 9A and 9B, image 160 may be, for example, 100 pixels wide by 100 pixels high, and each pixel can be represented by an eight bit value, e.g., an 8 bit paletted bitmap.

If desired, a halo can be drawn around boundary 162 by replacing each edge pixel with a 3×3 block of pixels centered on the original pixel, and then processing the resulting image with the boundary detection algorithm of Appendix A.

Those skilled in the art will recognize that in practicing the present invention other edge detection algorithms well known in the art could be adapted for substitution for the boundary algorithm represented in Appendix A.

In the present implementation, once boundary 162 of image 160 is identified from the graphics data, a plurality of perforation locations may be assigned to the boundary, at a predetermined default perforation resolution, such as for example 100 ppi, which may later be adjusted.

Alternatively, a polygonal perforation perimeter may be defined to surround boundary 162, at a predetermined perforation resolution, wherein a plurality of perforation locations may be assigned to the polygonal perforation perimeter. For example, a polygonal perforation perimeter 164, such as a rectangle, may be defined to intersects boundary 162 of image 160 represented in the graphics data at least at one perforation location of the plurality of perforation locations. As another example, the plurality of perforation locations are associated with a polygonal perforation perimeter 166, such as a rectangle, that surrounds boundary 162 of image 160, but does not intersect boundary 162 of image 160.

For example, a rectangular perforation perimeter may be determined by electronically scanning the data representing image 160 (FIG. 9A), or image boundary 162 (FIG. 9B) and recording the Cartesian coordinates (e.g., x,y coordinates) of the highest, lowest, leftmost, and rightmost edge pixel points. Accordingly, one of rectangular perforation perimeters 164 or 166 may be positioned to define a rectangle perforation boundary defining a plurality of perforation locations based on the four pixel points. In one implementation, for example, rectangular perforation perimeter 164 can be sized to intersect all four pixel points.

In another implementation, the embedding may be performed, for example, by perforation software running on computer 12, wherein a user selects a perforation boundary around the image to receive perforations. Such a perforation boundary might be entered, for example, by tracing a light pen around image 160 as presented on the monitor of computer 12, or by entering data points from a keyboard.

Further, as an alternative in the above implementations, it is contemplated that perforation coordinates could be supplied to imaging apparatus 14 via a data packet that accompanies each print job sent to imaging apparatus 14.

At step S206, an identifier is provided for identifying the non-printed color in the graphics data. In particular, at step S206, as mentioned above, software operating on computer 12, such as in the printer driver, automatically embeds the identifier as a predefined color sequence proceeded (or alternatively followed) by the non-printed color, i.e., perforation color, into the graphics data, preferably near the beginning of the graphics data to identity to the graphics data reader which color of a plurality of possible colors serves as the non-printed color, i.e., the perforation color for this perforation job.

At step S208, the graphics data, including the non-printed color, is read, for example, by imaging (perforation) apparatus 14.

At step S210, using the identifier, a plurality of perforation locations are identified by apparatus 14 based on the non-printed color.

At step S212, parameters of the perforation apparatus 14 are adjusted in accordance with the current perforation job.

In one implementation of the invention, the adjusting step may include the step of adjusting a perforation density, e.g., perforations per inch (ppi) of the plurality of perforation locations. The perforation density may be dependent on at least one of a print mode, e.g. draft, normal, etc., a media type and a media thickness of the sheet of print media 30. In addition, by setting the perforation density to a value wherein the perforations, i.e., holes, overlap, then a cut is made.

For example, a plain paper sheet may require less perforation per unit length than a photo paper sheet in order to achieve and acceptable punch-out of the perforated item from the surrounding scrap. Accordingly, for example, plain paper may be perforated at 30 ppi, whereas a photo paper sheet may be perforated at 40 ppi.

As another example, a thin media may require less perforation per unit length than a thick media in order to achieve and acceptable punch-out of the perforated item from the surrounding scrap. Accordingly, for example, thin paper may be perforated at 20 ppi, whereas as poster board may be perforated at 45 ppi.

In another implementation of the invention, the adjusting step may include the step of adjusting a perforation speed of forming the perforations at the plurality of perforation locations. The perforation speed may be adjusted, for example, based on factors such as media type, media thickness, and perforation resolution.

In another implementation of the invention, the adjusting step may include the step of adjusting a perforation force of perforation device 66 that forms the perforations. The perforation force may be determined, for example, by monitoring a motor torque of a motor, e.g., motor 44 of FIG. 1 or motor 142 of FIG. 7, that drives the respective perforation device 66, including tip portion 124 for puncturing the sheet of media 30 to form the perforations.

The motor torque is related to the current drawn by motor 44, 142. Thus, by monitoring the motor current, such as through a simple voltage divider circuit well known in the art, the motor current can be determined, and in turn, the perforation force. Accordingly, the perforation force may then be adjusted automatically to a desired force by adjusting the motor torque. As an example, the perforation force adjustment operation may be performed during a perforation of the sheet of print media sheet at a first perforation location occurrence of the plurality of perforation locations, so that subsequent perforations are formed with the proper perforation force. The motor torque can also be used in setting the perforation density and perforation speed

At step S214, the perforation of the sheet of media 30 is performed in accordance with the identifying and adjusting steps, set forth above. The actual perforation may be carried out by perforation system 10, as embodied in one of FIGS. 1 and 7, or alternatively, by some other perforation mechanism known in the art that is reconfigured to operate in accordance with the method of FIG. 8 of the present invention. Along with performing the perforation, the graphics data is printed as an image on the sheet of media 30.

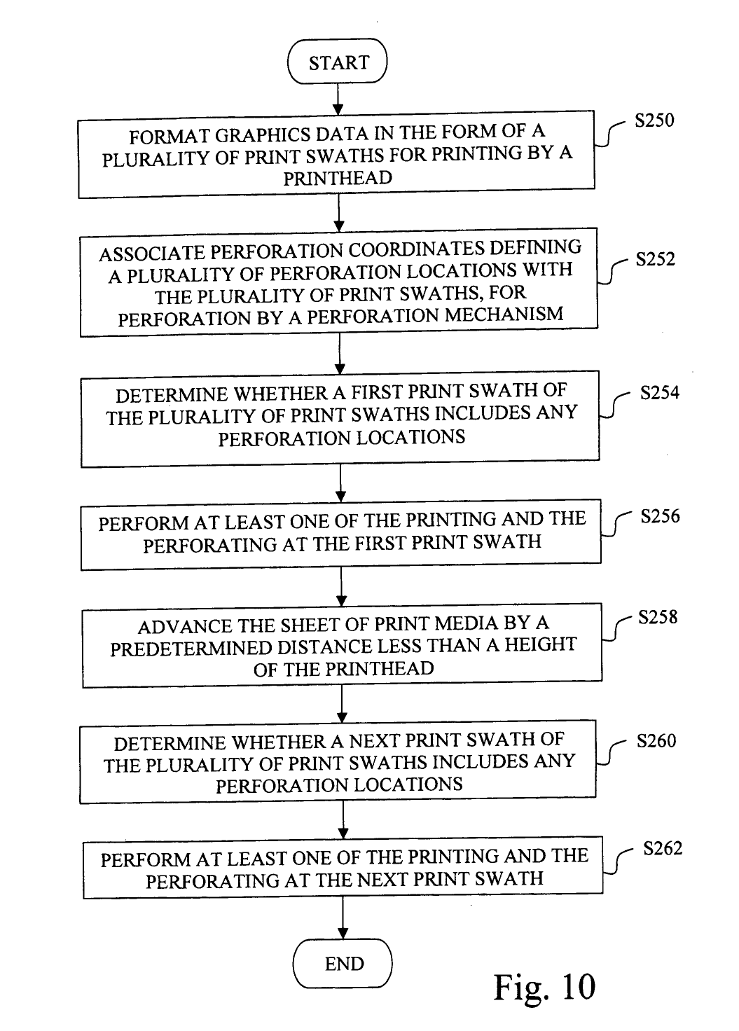

Such combined printing and perforating can be performed sequentially, or can be performed simultaneously, in a given printing swath with system 10 in either of the embodiments of FIGS. 1 and 7. FIG. 10 is a flowchart of an exemplary method for carrying out combined printing and perforating.

The method of FIG. 10 may be carried out in system 10 in either of the embodiments of FIGS. 1 and 7. However, for convenience and ease of understanding, the method of FIG. 10 will be described below with respect to only FIG. 1. It is to be understood, however, that the method of FIG. 10 may be used with the embodiment of FIG. 7 as well.

Imaging apparatus 14 includes carrier system 18 configured to carry a printhead, such as for example, either or both of monochrome printhead 38a and color printhead 38b, and is configured to carry a perforation forming mechanism, such as perforation forming mechanism 39. In the example that follows, for simplicity, reference will only be made to color printhead 38b. During printing, printhead 38b is traced over the sheet of print media 30, wherein the area traced by the printhead defines a print swath having a swath height equal to the spacing between the uppermost and lowermost ink jetting nozzles in printhead 38b. Typically, the sheet of print media is incrementally advanced by feed roller 58 prior to printhead 38b tracing the next print swath. Such concepts are well known in the art. A control unit, which may include the printer driver operating on computer 12 and controller 26 of imaging apparatus, is coupled to printhead 38b and to perforation forming mechanism 39.

The control unit is configured to perform the steps set forth in FIG. 10, as follows.

At step S250, graphics data is formatted into a plurality of print swaths for printing by printhead 38b.

At step S252, perforation coordinates defining a plurality of perforation locations are associated with the plurality of print swaths, for perforation by perforation forming mechanism 39.

At step S254, it is determined whether a first print swath of the plurality of print swaths includes any perforation locations.

At step S256, at least one of the printing and perforating operations are performed at the first print swath.

At step S258, the sheet of print media 30 is incrementally advanced by feed roller 58 by a predetermined distance less than a height of printhead 38b.

At step S260, it is determined whether a next print swath of the plurality of print swaths includes any perforation locations.

At step S262, at least one of the printing and the perforating are performed at the next print swath.

The control unit is further configured to repeat the steps S258, S260 and S262 until the sheet of print media 30 is completely processed.

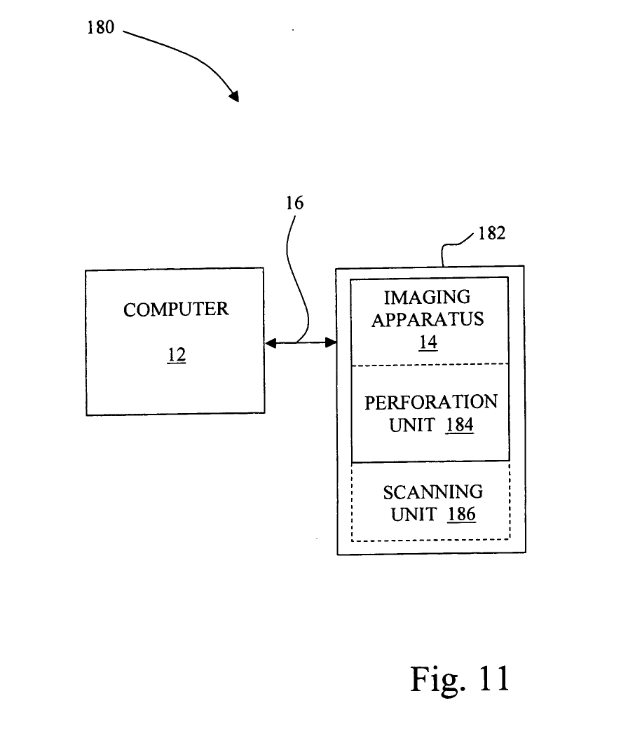

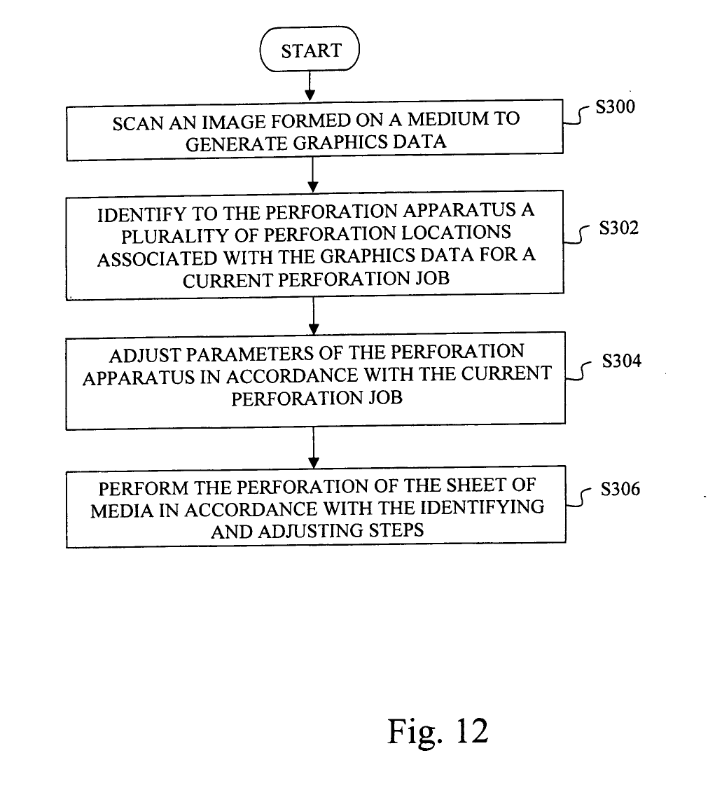

FIG. 11 shows another embodiment of the invention. A perforation system 180 includes computer 12 and a perforation apparatus 182. Apparatus 182 includes imaging apparatus 14, a perforation unit 184, and a scanning unit 186. Computer 12 is communicatively coupled to perforation apparatus 182 via communications link 16. Perforation unit 184 may be, for example, the perforation cartridge 34c as described above with reference to FIG. 1, or may be the perforator carriage 134 and its associated mechanisms, as described above with respect to FIG. 7. Scanner unit 186 may be, for example, a commercially available stand alone scanner, or a similar scanning unit physically incorporated into imaging apparatus 14. Perforation system 180 may be operated, for example, in accordance with the method described below with respect to FIG. 12.

The method for forming perforations in a sheet of media, as illustrated in the flowchart of FIG. 12, will be described below in conjunction with FIGS. 9A, 9B and 11.

At step S300, an image, such as image 160 of FIG. 9A that is formed on a medium, such as the sheet of print media 30, is scanned by scanning unit 186 to generate graphics data.

At step S302, a plurality of perforation locations associated with the graphics data is identified to perforation apparatus 182 for a current perforation job. Step S302 may be performed, for example, by utilizing the method steps S202, S204, S206, S208 and S210 of FIG. 8. Alternatively, methods known in the art for identifying perforation locations to a perforation apparatus could be adapted for performing step S302.

At step S304, parameters of perforation apparatus 182 are adjusted in accordance with the current perforation job. The parameter adjustment of step S304 may be performed, for example, in a manner as described above in step S212 of FIG. 8

At step S306, perforation of the sheet of media 30 is performed in accordance with identifying step S302 and adjusting step S304. Along with performing the perforation, the graphics data may be printed as an image on the sheet of media 30. Such combined printing and perforating can be performed sequentially, or can be performed simultaneously, in a given printing swath with system 10 in either of the embodiments of FIGS. 1 and 7. Step S306 may be performed, for example, in a manner as described above in step S214 of FIG. 8.

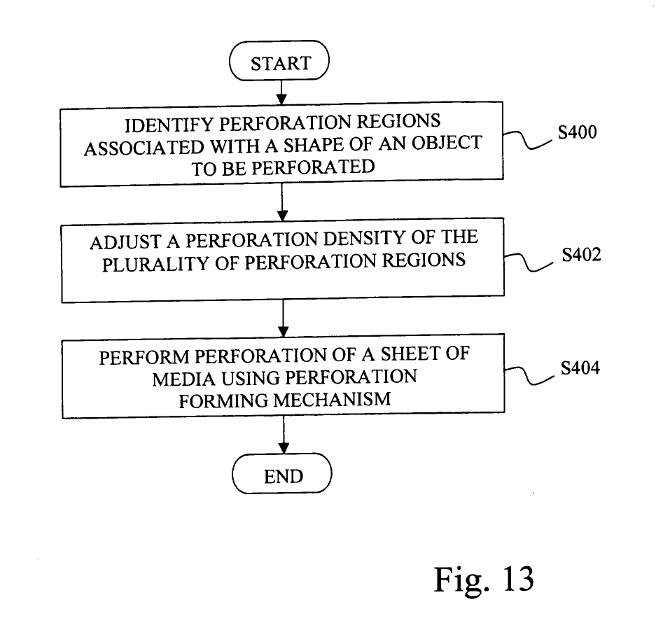

FIG. 13 is a flowchart of a method for performing perforation of an object using at least two different perforation densities. Such a method is useful to prevent an object to be perforated from being separated too easily from the media, e.g., sheet of paper, while permitting accurate separation of the object in areas where tearing of the object is most likely to occur.

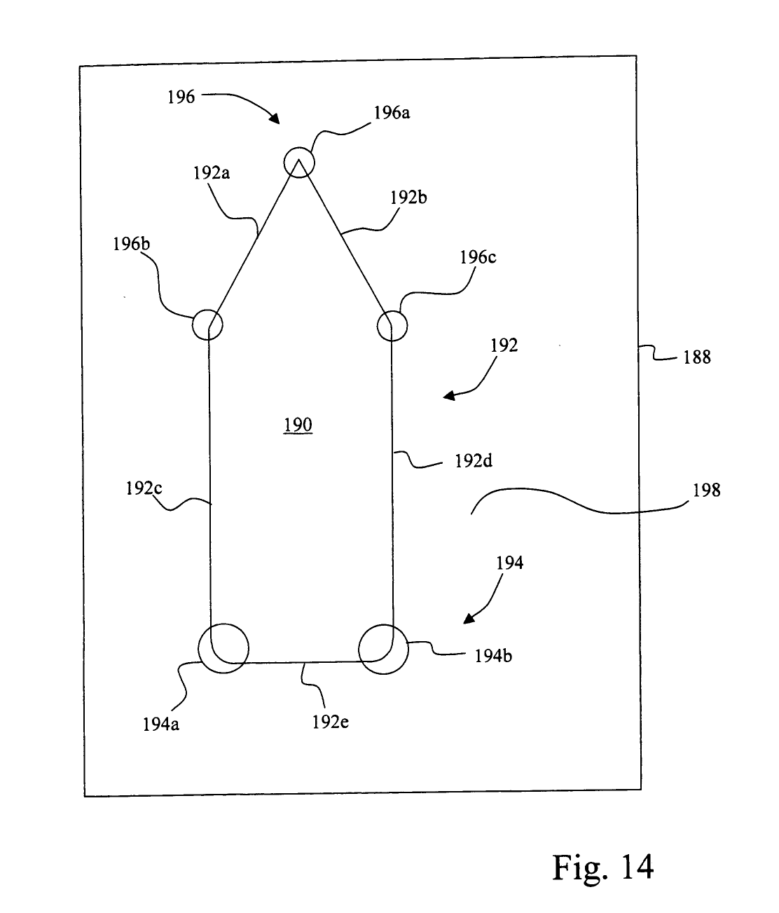

At step S400, a plurality of perforation regions associated with a shape of an object to be perforated is identified. For example, there is shown in FIG. 14 a sheet of media 188, such as a sheet of paper, which includes an object 190, such as, for example, a bookmarker, to be perforated. The plurality of perforation regions may include one or more straight perforation regions 192, such as straight perforation regions 192a, 192b, 192c, 192d and 192e; one or more curved perforation regions 194, such as curved perforation regions 194a and 194b; and one or more discontinuous perforation regions 196, such as discontinuous perforation regions 196a, 196b, and 196c. Gradually curved regions, such as for example a curved region defined by a curve having a theoretical radius of three inches or greater, may be considered as a straight perforation region. In addition, a sharply curved region, such as for example a curved region defined by a curve having a theoretical radius of 0.25 inches or less, may be considered to be a discontinuous perforation region.

At step S402, a perforation density of the plurality of perforation regions is adjusted in accordance with the shape of object 190. In accordance with the present invention, it is contemplated that two or more perforation densities may be used to perforate the same object. For example, a first perforation density may be selected for straight perforation regions 192, a second perforation density may be selected for curved perforation regions 194, and a third perforation density may be selected for discontinuous perforation regions 196. Preferably, in this embodiment, the perforation density selected for curved perforation regions 194 is greater than the perforation density selected for straight perforation region 192. Also, the perforation density selected for discontinuous perforation regions 196 is greater than the perforation density selected for straight perforation region 192.

For example, in order to facilitate the removal of object 190 from the surrounding material 198, the perforation density selected for curved perforation regions 194 and/or discontinuous perforation regions 196 may be set to a value, for example, of 75 to 80 perforations per inch, so as to significantly weaken the connection between object 190 and the surrounding material 198 in the curved perforation regions 194 and/or discontinuous perforation regions 196. However, the perforation density for straight perforation regions 192 may be set, for example, at 30 to 40 perforations per inch so as to retain enough material between adjacent perforation holes to maintain the integrity of the sheet of media 188 during the perforation process, i.e., to prevent premature removal of object 190 from the surrounding material 198, which could result in a paper jam in the perforation system, such as for example, perforation system 10 including perforation forming mechanism 39.

As another example, the perforation density selected for curved perforation regions 194 and/or discontinuous perforation regions 196 may be set to a value, for example, of greater than 80 perforations per inch, wherein the perforations, i.e., holes, overlap so as to form a cut. However, the perforation density for straight perforation regions 192 may be set, for example, at 40 perforations per inch so as to maintain the integrity of the sheet of media 188 during the perforation process, i.e., to prevent premature removal of object 190 from the surrounding material 198, which could result in a jam of the perforation system, such as for example, perforation system 10.

At step S404, the perforation of sheet of media 188 is performed by perforation forming mechanism 39, for example, in accordance with steps S400 and S402. If perforation forming mechanism 39 is moved over the sheet of media 188 at a constant speed, then the perforation density may be controlled by varying the rotational speed of perforation motor 76. For example, if perforation forming mechanism 39 is moved over the sheet of media 188 at a constant speed, then an increase in the rotational speed of perforation motor 76 will result in a higher perforation density, and a decrease in the rotational speed of perforation motor 76 will result in a lower perforation density. The concepts set for above may be applied in a perforation system where the media, such as the sheet of media 188, is transported in a single direction, or in a perforation system where the media is transported bi-directionally, e.g., in a reciprocating manner under perforation forming mechanism 39. In a system where the media is transported bi-directionally, drive unit 60 will be configured to rotate feed roller 58 in both forward and reverse directions.

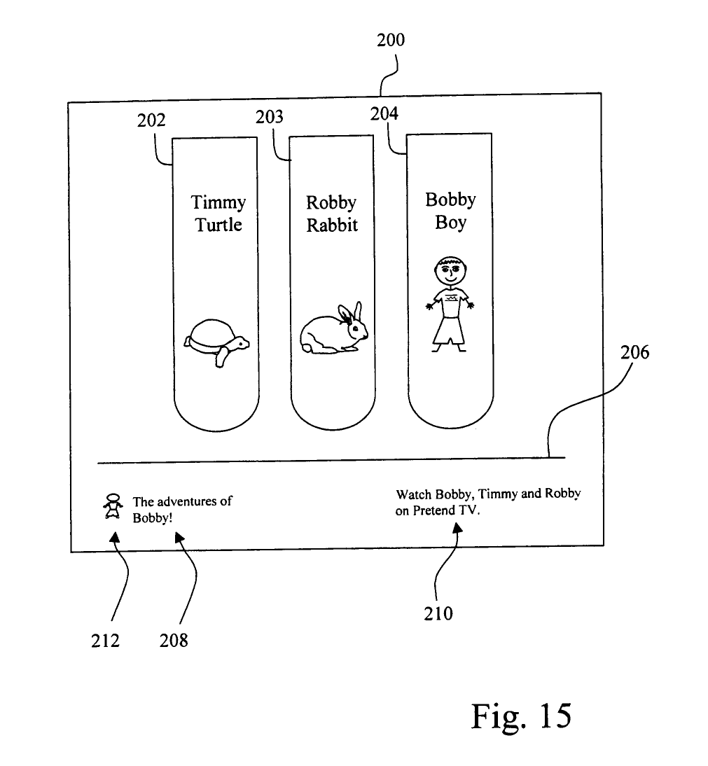

Another aspect of the present invention will now be described with respect to FIGS. 15-18.

In FIG. 15, there is shown a computer screen 200 which includes objects 202, 203 and 204, such as for example bookmarkers, that a user desires to print and separate from a media. In addition, however, computer screen 200 includes a line 206, text 208, 210 and a logo 212 that a user does not desire to have separated, and if separated, e.g., by perforation, could result in an excessive number of paper chads falling into the perforation system, such as for example, perforation system 10, resulting in a paper jam.

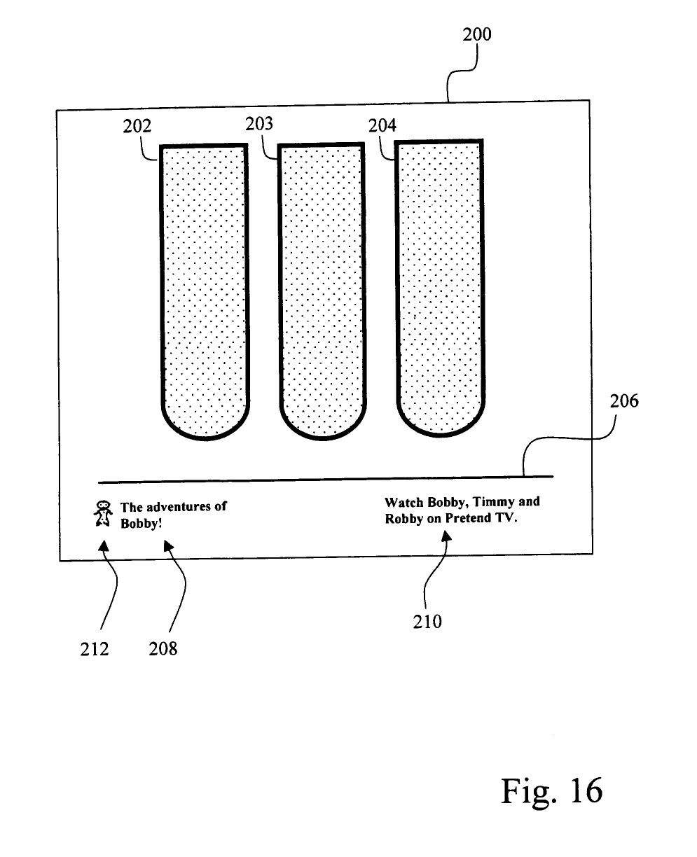

FIG. 16 illustrates how an boundary detection algorithm, such as that described above with respect to Appendix A in relation to FIGS. 8, 9A and 9B, would identify the perforation regions of computer screen 200, if the cut path determination enhancements of the current aspect of the present invention were not utilized. In particular, all the areas, including objects 202, 203, 204; line 206; text 208, 210; and a logo 212 would be designated for perforation, or cutting, as indicated by the thick lines and bold text, and the interior regions within the perforation, or cutting, boundary being represented by a dotted fill.

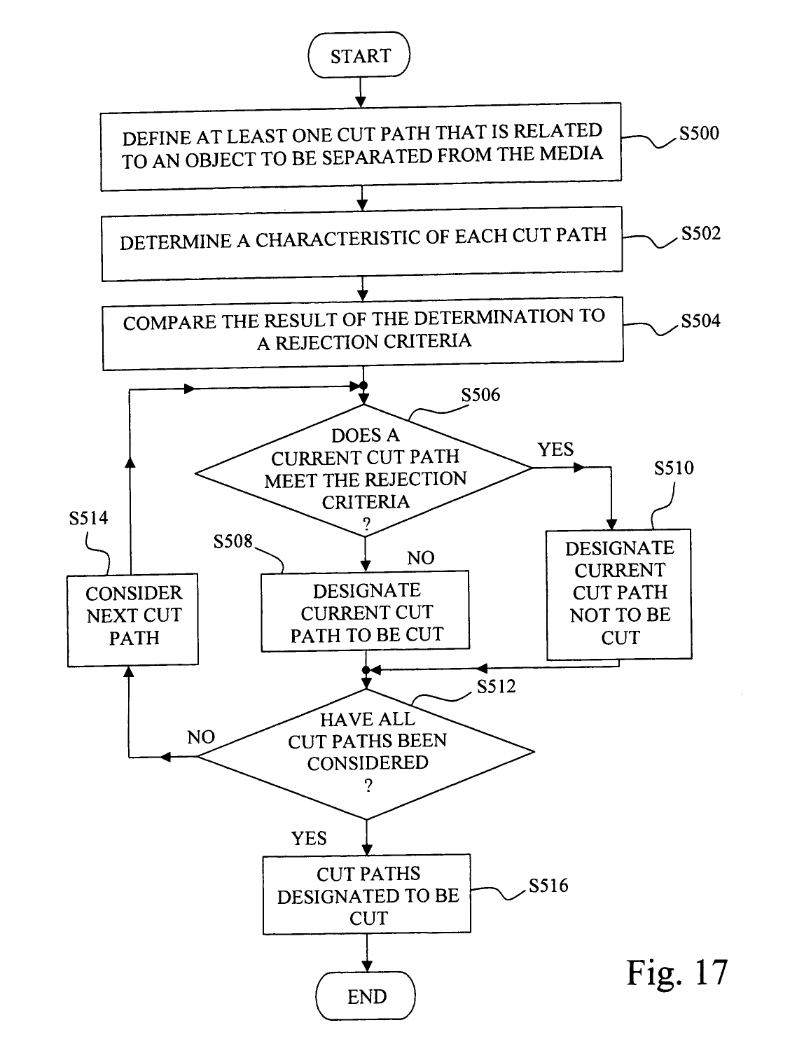

In order to differentiate between objects 202, 203, 204 to be perforated or cut, and the line 206; text 208, 210; and logo 212 that are not to be perforated or cut, the current aspect of the present invention utilizes a method, as described below with respect to the flowchart of FIG. 17 that distinguishes objects to be separated from the media from objects not to be separated from the media on the basis of a designated pixel density obtained after application of the boundary detection algorithm described above. As used herein, the term “pixel density” encompasses both an image data density, as well as a perforation density.

In the description that follows, the term “cut path” will be used to describe a path associated with a continuous cut or a set of spaced perforations, which identifies, for example, the outer boundary of the object to be removed from the surrounding material of the media. This cut path may be virtual, i.e., defined only in the processor processing the data relating to the cut path, as opposed to displaying or printing the cut path on a visually perceptible medium, e.g., a computer screen or a sheet of print media.

Accordingly, FIG. 17 is a general flow chart of a method for filtering objects to be separated from a media. The method of FIG. 17 may be implemented by a perforation/cutting system that includes a mechanism, such as for example, a perforation forming mechanism 39, a blade cutter, or a laser beam cutter, for aiding in separating an object from a media, wherein a controller, such as controller 26, executes instructions for performing the method steps, e.g., steps S500-S516 set forth below.

At step S500, at least one cut path is defined that is related to an object to be separated from said media. Each cut path may be defined by assigning cut path data to the respective cut path, wherein each pixel of the cut path data is set to a predefined state. For example, as shown in FIG. 16, each defined cut path is represented for sake of illustration by a thick line. However, the predetermined state may be, for example, a particular color. Also, each cut path may, if desired, be designated by a different color. For example, the color corresponding to the cut path associated with object 202 may be different from the color corresponding to the cut path of object 204. Further, each cut path may be represented, for example, by vector data or by raster data.

At step S502, a characteristic of each cut path is determined. The characteristic may be, for example, a pixel density within a predefined area. The predefined area may be, for example, bounded by each cut path, and thus, each predefined area may be associated with a corresponding cut path. Thus, in the example shown in FIG. 16, the pixel density for each of the respective cut paths associated with objects 202, 203, 204; line 206; text 208, 210; and logo 212 is determined.

At step S504, the result of the determination made at step S502 is compared to a rejection criteria. The rejection criteria may be, for example, a threshold corresponding to a maximum pixel density within a predefined area. Thus, for example, the pixel density for the predefined area as determined in step S502 is compared to the threshold to determine whether the rejection criteria has been met.

At step S506, it is determined whether a current cut path meets the rejection criteria. If the determination at step S506 is NO, then the process proceeds to step S508 wherein the current cut path is designated as a path to be cut. Such a designation may be in the form of an assignment of a particular color to the cut path designated to be cut. If the determination at step S506 is YES, then the process proceeds to step S510 wherein the current cut path is designated as a path not to be cut.

An exemplary pseudo code for performing step S500 is attached in Appendix B. In the pseudo code, it is assumed that in a rectangular array of pixels, each pixel can have multiple values, such as for example, a value representing a cut path or a value representing background.

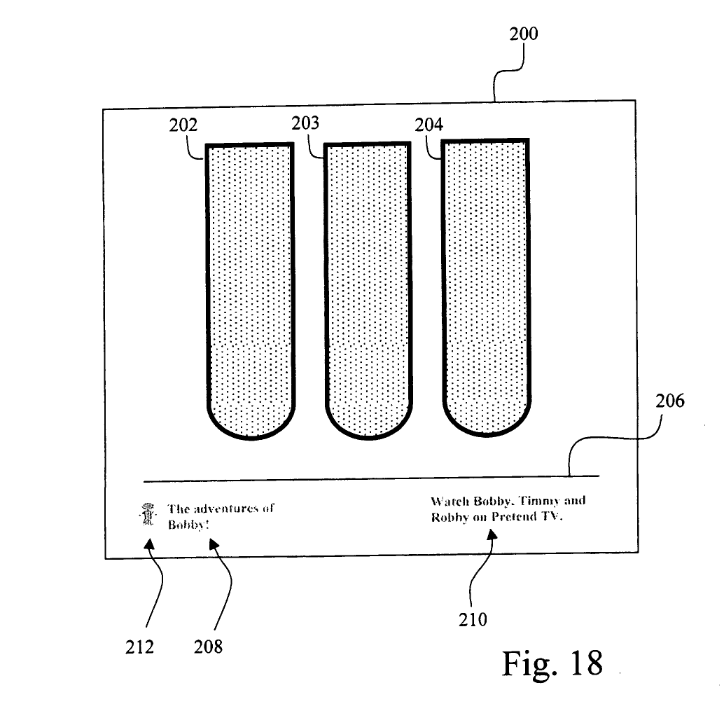

Referring to FIG. 18, based on the comparison of the threshold with the pixel density characteristics of objects 202, 203, 204; line 206; text 208, 210; and logo 212, only objects 202, 203 and 204 will be designated as a path to be cut. Thus, in this example, the thickened line, text and logo associated with line 206; text 208, 210; and logo 212, respectively, as shown in FIG. 16, is removed as shown in FIG. 18.

Following steps S508 and S510, at step S512 it is determined whether all cut paths have been considered. If the determination at step S512 is NO, then the process proceeds to step S514 to select the next cut path to be considered, and the process returns to step S506. If the determination at step S512 is YES, then the process proceeds to step S516 wherein the cut paths designated in step S508 to be cut are cut.

Accordingly, at step S516, the cut paths designated in step S508 to be cut are cut to facilitate separation of the object from the surrounding material of the media. Cutting may be achieved by performing a continuous cut in the media along the cut path, such as for example, by overlapping perforations, by a blade cut or by a laser beam cut. Also, cutting may be achieved by forming spaced perforation holes in the media along the cut path designated to be cut.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

APPENDIX A
Boundary Detection Algorithm, in C++ Programming Language

```
int Width=100, Height=100;
int Background, Data, Marked, Edge;
short int ImageBuffer[Width][Height];
void flood(int x, int y)
{
  int head, tail,i;
// if the current pixel is Marked or Edge escape out of routine
  if (ImageBuffer[x][y]==Marked) return;
  if (ImageBuffer[x][y]==Edge) return;
// if the current pixel is Data, mark it as Edge and return
  if (ImageBuffer[x][y]==Data){
        ImageBuffer[x][y]=Edge;
      return;
  }
// find left edge of screen or data on left side
  head=x;
  while ( (ImageBuffer[head][y] ==Background) && (head > 0)){
    head−−;
  }
  if(ImageBuffer[head][y]==Data){
      ImageBuffer[head][y]=Edge;
  }
  if(head) head++;
// find right edge of screen or data on left side
  tail=x;
  while ( (ImageBuffer[tail][y]==Background) && (tail < (Width−1))){
    tail++;
  }
  if(ImageBuffer[tail][y]==Data){
        ImageBuffer[tail][y]=Edge;
  }
  tail−−;
  if(head>tail) {
    head=x;
    tail=x;
  }
// set from head to tail to Marked
  for(i=head;i!=(tail+1);i++) ImageBuffer[i][y]=Marked;
// look for open pixels above
  if(y>0) {
    for(i=head;i!=(tail+1);i++) flood(i,y−1);
  }
// look for open pixels below
  if(y<Height) {
    for(i=head;i!=(tail+1);i++) flood(i,y+1);
  }
}
int main( ) {
  int x, y;
  unsigned char ch;
  int loop,z;
// read image into ImageBuffer
  ReadImageIntoImageBuffer( );
// change every pixel to either Background or Data
  for(y=0;y!=Height;y++) {
    for(x=0;x!=Width;x++) {
        ch=ImageBuffer[x][y];
      if((x==0) && (y==0)) {
          Background=ch;
          Data=(Background+20) & 0xff;
          Marked=(Background + 40) & 0xff;
          Edge=(Background + 70) & 0xff;
      }
      if (!(ch==Background)) ch=Data;
        ImageBuffer[x][y]=ch;
    }
  }
// ok, now we're ready to do the flood fill
  flood(1,1);
// go to only background and edges
  for(y=0;y!=Height;y++) {
    for(x=0;x!=Width;x++) {
        if(ImageBuffer[x][y]!=Edge) ImageBuffer[x][y]=Background;
    }
  }
    return 0;
                    }
```

APPENDIX B
Pseudo C code to identify cut paths

```
define BACKGROUND_COLOR=0;
define CUT_PATH_COLOR-1;
define  WORKING_COLOR_BASE-2;
int pixel [X] [Y];
/* recursive function to mark all touching pixels */
int  MarkTouching (int x, int y, int color) {
  if (pixel [x] [y] !-CUT_PATH_COLOR) return (0); /*abort if this
pixel is not an unprocessed cut path*/
  pixel [x] [y]-color;  /*mark this pixel*/
/* try marking the adjacent pixels */
  if(x>0 && y>0) MarkTouching (x−1, y−1, color);
  if (y>0) MarkTouching (x, y−1, color);
  if (x<(X−1) && y>0) MarkTouching (x+1, y−1, color);
  if (x>0) MarkTouching (x−1, y, color);
  if (x<(X−1)) MarkTouching (x+1, y, color);
  if (x>0 && y<(Y−1)) MarkTouching (x−1, y+1, color);
  if (y<(Y−1)) MarkTouching (x, y+1, color);
  if (x<(X−1) && Y<(Y−1)) MarkTouching (x+1, y+1, color);
  return (1);
)
main ( )
{
  int ii, jj;
  int object_number=0;
  LoadPixels( );  /* initialize pixel array (function not shown) */
  for (ii-0; ii<x; ii++){
      for (jj-0; jj<Y; jj++){
            if (MarkTouching (ii, jj,
object_number+WORKING_COLOR_BASE--1) {
                object number++;
          }
      }
  }
}
```

1. A method for filtering objects to be separated from a media, comprising:
defining at least one cut path related to an object to be separated from said media;
determining a characteristic of each said cut path;
comparing a result of the determination made in the determining step to a rejection criteria;
suppressing cutting of any said cut path that meets said rejection criteria; and
cutting said media at each said cut path that does not meet said rejection criteria.

2. The method of claim 1, wherein said at least one cut path is defined by assigning cut path data to said at least one cut path, wherein each pixel of said cut path data is set to a predefined state.

3. The method of claim 2, wherein said predefined state is associated with a particular color.

4. The method of claim 1, wherein said characteristic of each said cut path is a pixel density within a predefined area.

5. The method of claim 1, wherein said rejection criteria is a threshold corresponding to a maximum pixel density within a predefined area.

6. The method of claim 1, wherein said cutting comprises performing a continuous cut in said media along said cut path.

7. The method of claim 6, wherein said continuous cut is formed by overlapping perforations.

8. The method of claim 1, wherein said cutting comprises forming spaced perforation holes in said media along said cut path.

9. The method of claim 1, wherein said cutting is performed by one of a perforation forming mechanism, a blade or a laser beam.

10. The method of claim 1, wherein each said cut path is represented by one of vector data and raster data.

11. A system including a mechanism for aiding in separating an object from a media, said system including a controller executing instructions for performing the steps of:
defining at least one cut path related to an object to be separated from said media;
determining a characteristic of each said cut path;
comparing a result of the determination made in the determining step to a rejection criteria;
suppressing cutting of any said cut path that meets said rejection criteria; and
cutting said media at each said cut path that does not meet said rejection criteria.

12. The system of claim 11, wherein said at least one cut path is defined by assigning cut path data to said at least one cut path, wherein each pixel of said cut path data is set to a predefined state.

13. The system of claim 12, wherein said predefined state is associated with a particular color.

14. The system of claim 11, wherein said characteristic of each said cut path is a pixel density within a predefined area.

15. The system of claim 11, wherein said rejection criteria is a pixel density within a predefined area.

16. The system of claim 11, wherein said cutting comprises performing a continuous cut in said media along said cut path.

17. The system of claim 16, wherein said continuous cut is formed by overlapping perforations.

18. The system of claim 11, wherein said cutting comprises forming spaced perforation holes in said media along said cut path.

19. The system of claim 11, wherein said cutting is performed by one of a perforation forming mechanism, a blade or a laser beam.

20. The system of claim 11, wherein each said cut path is represented by one of vector data and raster data.

21. A method for forming perforations in a sheet of media with a perforation system, comprising:
identifying a plurality of perforation regions associated with a shape of an object to be perforated;
adjusting a perforation density of said plurality of perforation regions in accordance with said shape of said object; and
performing perforation of said sheet of media in accordance with said identifying and adjusting steps.

22. The method of claim 21, said plurality of perforation regions including a straight perforation region and a curved perforation region, wherein a first perforation density is selected for said straight perforation region and a second perforation density is selected for said curved perforation region.

23. The method of claim 22, wherein said second perforation density is greater than said first perforation density.

24. The method of claim 23, wherein said second perforation density is set to form a cut.

25. The method of claim 21, said plurality of perforation regions including a straight perforation region and a discontinuous perforation region, wherein a first perforation density is selected for said straight perforation region and a second perforation density is selected for said discontinuous perforation region.

26. The method of claim 25, wherein said second perforation density is greater than said first perforation density.

27. The method of claim 26, wherein said second perforation density is set to form a cut.

28. The method of claim 21, wherein at least two different perforation densities are used in said perforation of said sheet of media.

29. The method of claim 21, wherein at least three different perforation densities are used in said perforation of said sheet of media.
